(19) United States
(12) Patent Application Publication
(10) Pub. No.: US 2006/0277294 A1
(43) Pub. Date: Dec. 7, 2006

(54) Computer management system

(76) Inventors: Dimitri Kanevsky, Ossining, NY (US); Alexander Zlatsin, Yorktown Heights, NY (US)

Correspondence Address: HARRINGTON & SMITH, LLP, 4 RESEARCH DRIVE, SHELTON, CT, 06484-6212, US

(21) Appl. No.: 11/147,787

(22) Filed: Jun. 7, 2005

(51) Int. Cl. G06F 15/173

(52) U.S. Cl. 709/224

(57) ABSTRACT

A computer management system including a system manager, a user behavior system, and an integrator system. The system manager is coupled to a plurality of clients. The user behavior system is adapted to receive an individual user activity information regarding physical behavior of at least one user of at least one of the clients. The integrator system is adapted to modify at least one operation of the system manager based upon the individual user activity information received by the user behavior system.

### BACKGROUND OF THE INVENTION

1. Field of the Invention

The present invention relates to a computer management system and, more particularly, to managing a computer system based, at least partially, upon input regarding actions and/or activity and/or predicted activity of users of the computer system.

2. Brief Description of Prior Developments

Chat messenger software, such as AOL chat messenger software, is adapted to know that a user's computer is not busy or that the user is absent.

System management in computer systems is normally done taking into account specific machine parameters and without taking into account various human factors. For example system updates and/or maintenance is usually done at scheduled times. Generally, small updates and/or fixes are pushed during the day and upgrades are done at night under the assumption that the machine, such as a client, is under utilized. The fact that the person is working at night on the computer, or computer resources are being used, is not considered. Furthermore, this simple assumption is of no use for laptop computer users who typically disconnect or even shutdown their machines at night. As another example, relocating CPU resources is usually done taking into account how resources are used during a specified period of time.

Examples of problems are the following. Antivirus programs often work in computers by some schedule which may not be convenient for users. When the antivirus program works in the computer, it is difficult to do other tasks on the computer. Another example is in regard to management of software licenses. Currently, when licensed software is being used, the license file will get locked by a user and the total number of available licenses will be reduced independently of whether or not the software is actually being used by a user or is merely locked by the user's computer. For example, the user can start a licensed software program and leave for lunch, or be involved in a conversation, while the license continues to be locked. There is a limitation on how many people can use this application simultaneously based upon the number of licenses available. If there are more people that want to use this program, they cannot. They need to wait until other people are finished and release the license lock.

Another example is in regard to managing email, such as junk email or SPAM for example. Existing SPAM filters for emails sometimes miss junk. People still receive junk email. Or the filter does not allow good email to pass thinking that it is junk email.

If there are additional system resources that are not used for some time, there is a desire that they be allocated to a different machine (e.g., a client) that is connected to network such as for a client that is a heavy user of CPU at the given time. There is a desire to reduce the waiting time that is spent to identify how much resources are needed, such as if human factors are taken into account as described below with the description of the invention.

### SUMMARY OF THE INVENTION

In accordance with one aspect of the invention, a computer management system is provided including a system manager, a user behavior system, and an integrator system. The system manager is coupled to a plurality of clients. The user behavior system is adapted to receive an individual user activity information regarding physical behavior of at least one user of at least one of the clients. The integrator system is adapted to modify at least one operation of the system manager based upon the individual user activity information received by the user behavior system.

In accordance with one method of the invention, a method for operating a computer system manager is provided comprising providing a user behavior system adapted to receive an individual user activity information regarding physical behavior of a user at a client coupled to the system manager; and modifying at least one operation of the system manager based upon the individual user activity information received by the user behavior system.

In accordance with another method of the invention, a method for providing feedback is provided comprising determining a desired action associated with a group of subjects; receiving data indicative of a physical characteristic of at least one member of the group of subjects; determining a course of action based, at least in part, on the physical characteristic and the desired action; and providing a notification based on the course of action.

In accordance with another aspect of the invention, a system for facilitating feedback is provided comprising a memory; a communication port; and a processor connected to the memory and the communication port, the processor being operative to receive data indicative of a physical characteristic of a first subject and a physical characteristic of a second subject; determine an evaluation of the data; and provide a notification regarding the evaluation to device.

In accordance with another aspect of the invention, a computer program product in a computer readable medium for using feedback is provided comprising first instructions for obtaining receiving data representative of a physical characteristic of a first subject and a physical characteristic of a second subject; second instructions for preparing an evaluation of the data; and third instructions for sending data indicative of the evaluation of the data to a device.

### BRIEF DESCRIPTION OF THE DRAWINGS

The foregoing aspects and other features of the invention are explained in the following description, taken in connection with the accompanying drawings, wherein:

FIG. 1 is a diagram showing a computer system having a computer management system incorporating features of the invention;

FIG. 2 is a diagram showing one example of the system manager used in the computer system shown in FIG. 1;

FIG. 3 is a diagram showing one example of the human management used in the computer system shown in FIG. 1;

FIG. 4 is a diagram showing one example of use of biometrics database and interpretation of biometrics data with other components;

FIG. 5 is a diagram showing one example of an integrator used with the human management and system manager; and

FIG. 6 is a flow chart showing steps used in one example of a method of the invention.

### DETAILED DESCRIPTION OF THE PREFERRED EMBODIMENT

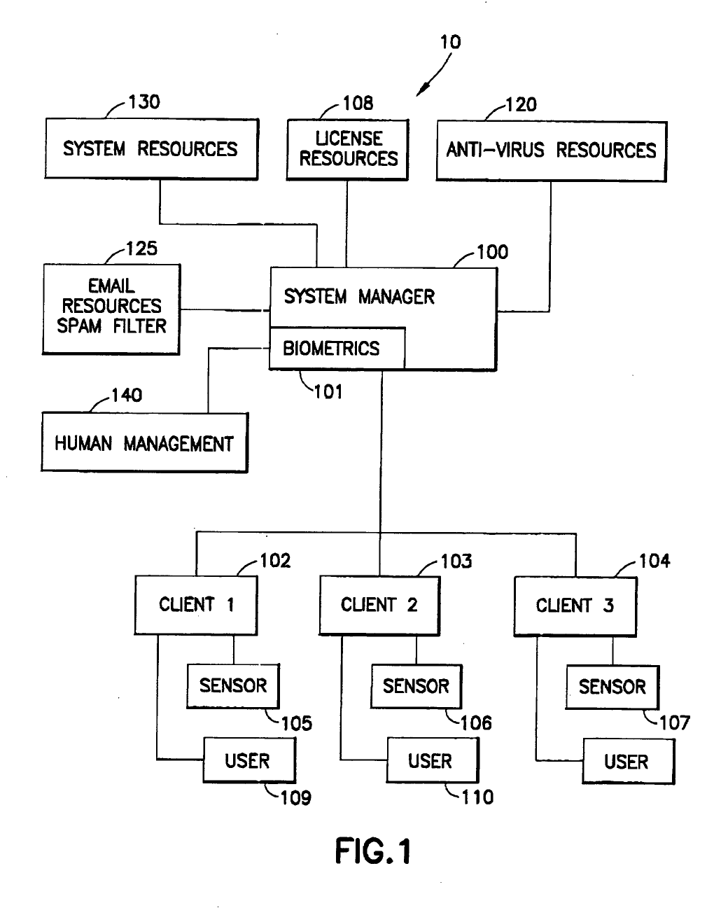

Referring to FIG. 1, there is shown a block diagram of a computer management system 10 incorporating features of the invention. Although the invention will be described with reference to the exemplary embodiment shown in the drawings, it should be understood that the invention can be embodied in many alternate forms of embodiments. In addition, any suitable size, shape or type of elements or materials could be used.

The management system 10 comprises a system manager 100 connected to human management 140. System manager contains block 101 that has biometrics constraints. These biometric constraints can define how the system manager works, at least partially. System manager 100 can be connected with different system resources including, for example, antivirus resources 120, license resources 108, email SPAM filters 125, general system resources 130, and client systems 102, 103, 104. Any suitable client systems could be coupled to the system manager. Client 1 102 is connected to sensors 105. Client 2 103 is connected to sensors 106. Client 3 104 is connected to sensors 107. User 109 uses client 1. User 110 uses client 2. Biometric sensors can include, for example, microphones and cameras. The system manager 100 can provide resources for the clients 102-104 and redistribute resources depending on biometric constraint and information that it receives from human management.

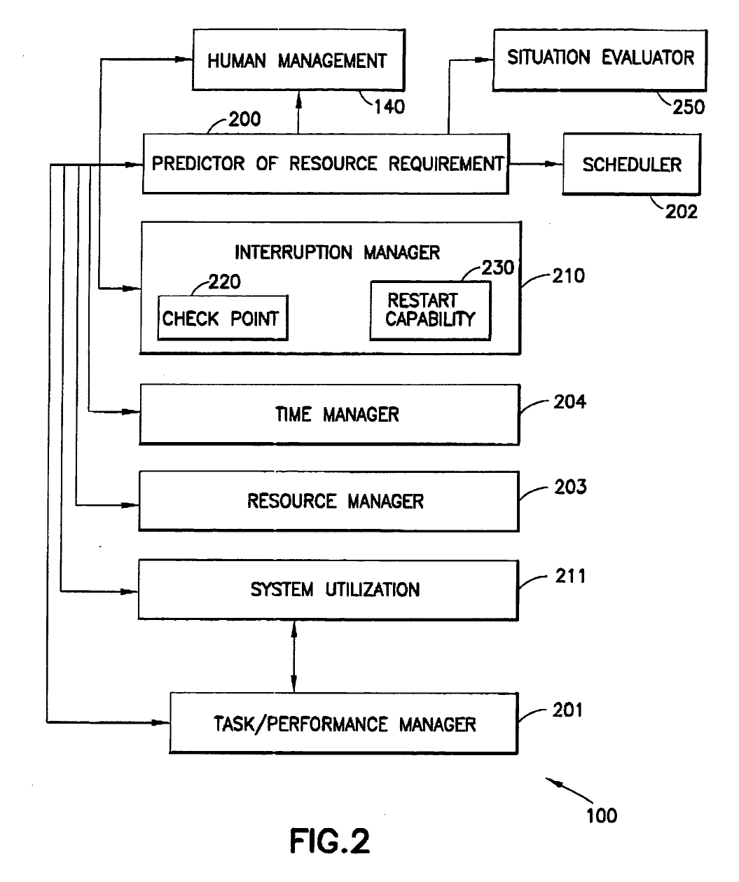

FIG. 2 is a block diagram of one example of a system manager 100. The system manager can have the ability to predict resources requirements. The system manager can have the ability to have management for interruption. For example, if a user suddenly comes back to his or her computer, the system manager can be able to stop a program or operation, such as an antivirus program, and can memorize changes so that it can continue the program or operation after the user leaves the client computer again.

If, for example, an antivirus program does scanning, but the program only scans some directories,-because the user had come back so it did not finish scanning all directories, it preferably can remember where it stopped and does not need to continue scanning. The system manager can wait for the user to leave the client computer again so the system manager can activate the antivirus program again to continue scanning for remaining directories. This feature requires redesigning of existing antivirus programs to allow them to provide interruption. In the case that an antivirus application does not have the interruption feature, it can just tell the user such as “I'm sorry, I did not guess that you came back. I will stop antivirus if and do again later if you wish”, for example.

Therefore, there can be two options for an antivirus program and similar system resources applications. One option uses a standard antivirus program. If it did not finish when user comes back, it can just display a note such as “I'm sorry, but I need to finish.” With the second option using a smart antivirus program, it will be able to stop and wait until the user leaves the client computer again.

The system manager interruption block can include the check point and restart capability. With any interruption of the program execution, the check points can be taken and, when the program restarts, it can start from the check point. In other words, it can know exactly where it ends and it can know exactly where to continue from.

The system manager 100 can include a predictor of resource requirements 200. The predictor of resource requirements 200 can determine what kind of tasks can be performed at this moment at this period. Predictor of resource requirement 200 is connected to performance/task manager 201. Performance/task manager 201 can have a set of tasks that need to be performed. Predictor of resource requirements 200 is also preferably connected to scheduler 202. Scheduler 202 can choose which task to do first depending on resources that are expected to be available. Predictor of resource requirements 200 is also preferably connected to resource manager 203 and time manager 204.

An interruption manager 210 can be provided. Interruption manager 210 can stop some jobs in emergency situation, for example when the user comes back to his computer, and it can be adapted to save the job(s) or portion(s) of the job(s) that it already did and continue to do the needed job(s) or portion of job(s) when resources are again available. For example, the antivirus program scenarios described above. The interruption manager 210 can contain check points block 220 and restart capability 230. Predictor of resource requirements 200 and interruption manager 210 are connected to human management 140. Human management can inform system manager 100 about changes in external situation that affect resources. Therefore, human management 140 can use situation evaluator 250 to evaluate a situation. Situation evaluator 250 can receive information from human management 140 and information about resources and evaluate if information about human behavior should affect resources.

As noted above, another block in the system manager is a time manager 204. The time manager 204 can track timeline and resource allocation. Resource manager 203 can track the system utilization and performance/task manager. System utilization 211 can estimate the load of the computer such as background jobs that are running on this particular system and whether the computer is busy doing anything else. Performance manager 203 can interact with the system utilization component and determine if the computer is loaded or not. It can submit additional tasks.

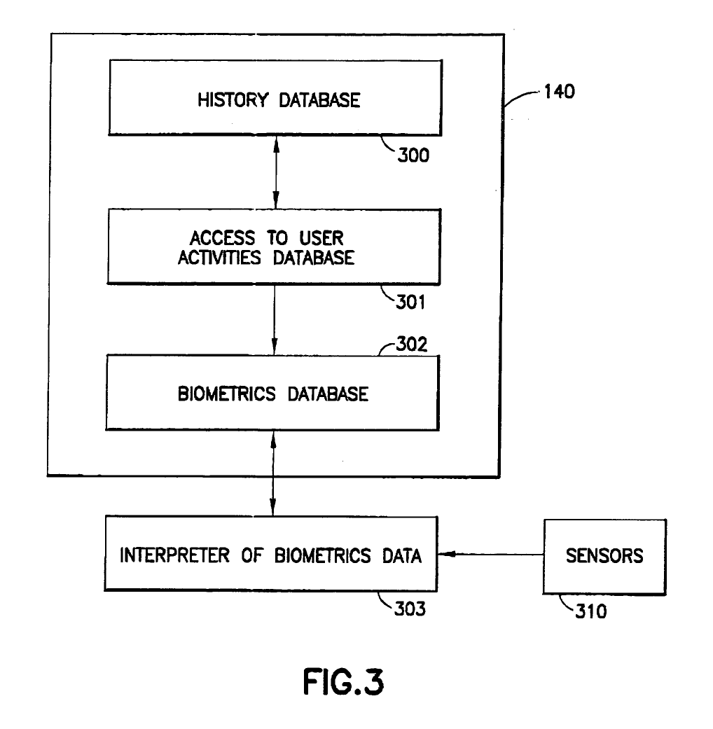

Referring also to FIG. 3 one example of the human management 140 is shown. Human management 140 can contain a history database 300. History database 300 can contain information about user behavior, including for example different categories of users. The system can have, for example, a user which it knows belongs to a specific category. For example, if the user is a lawyer, the human management can know that one can expect that the user will work at night. However, if the human management knows that the user is a secretary contractor, the human management knows that she always leave at 5 o'clock p.m. This system human management also can have access to user activities database 301. The user activities database can have access to calendars, to email system, to telephones, etc. The human management 140 also preferably has a biometrics database 302. Biometric database 302 allows the system to interpret biometric information that the human management receives. For example, it can receive from a camera or sensor(s) 310 information that the user left the office. The human management 140 can find in the biometric database 302 that this means it should be interpreted that resources are now available. Therefore, we have interpretation of biometrics data that come from sensor(s) 310, biometric data 303, and biometric database 302.

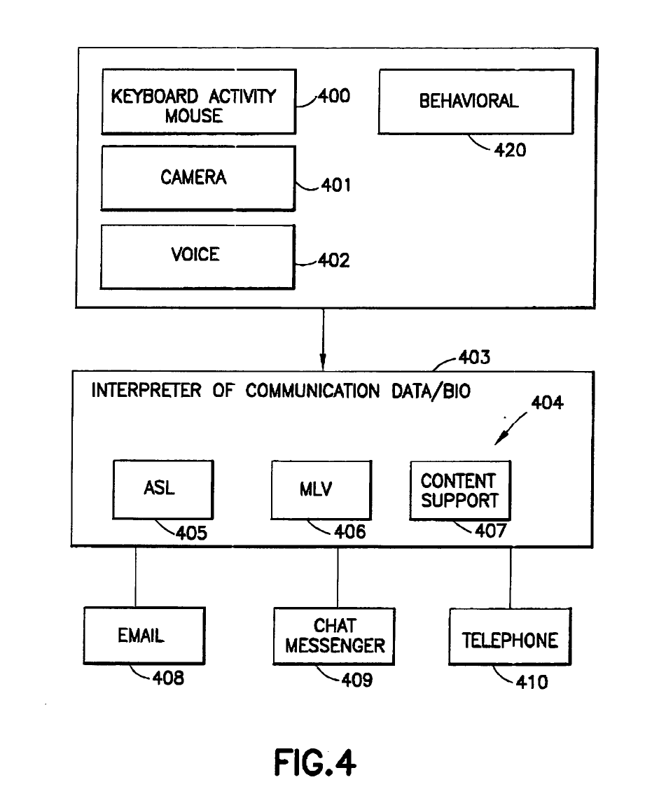

Referring also to FIG. 4 one example of use of biometrics database 302 and interpretation of biometrics data 303 will be described. Some examples of possible biometrics that can be used for system and human management can be found in U.S. Pat. No. 6,421,453, which is hereby incorporated by reference in its entirety, which relates to an apparatus and method for user recognition employing behavioral passwords. One example is keyboard activities. If a user does not use a keyboard for some time, the system can decide that computer is not active. This can also be used with the present invention with a biometrics mouse 400, a camera 401, heat sensors, voice sensor 402, and behavior biometrics 420. Biometrics interpreted by Interpretation of communication data/biometrics 403 can be provided for interpretation of communication data such as email 408, chat messages 409 and telephones 410. It can use automatic speech recognition 405, natural language understanding 406, and/or content support 407. So it can detect some phrases that give information about a user's intention. It can use biometrics to detect that a user relaxed it or used a computer intensively.

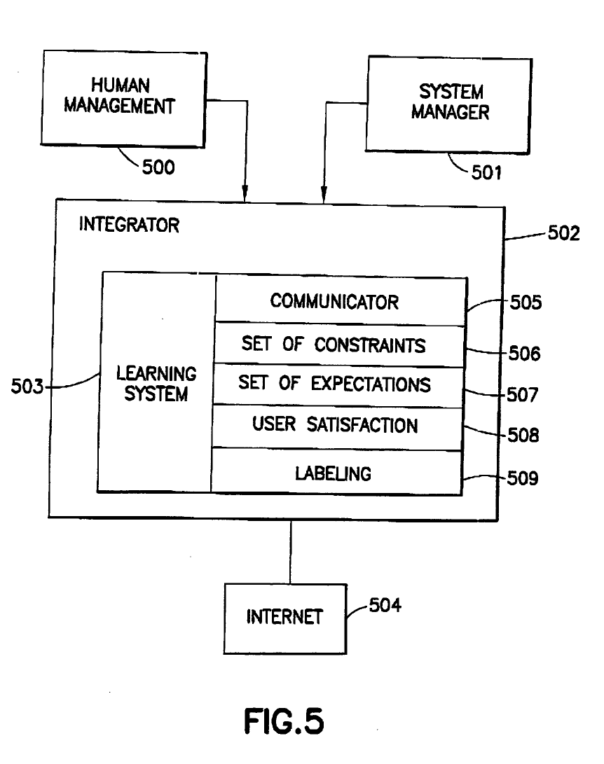

Referring also to FIG. 5, some aspects of an example of integration of a human management and a system manager will be described. Human management 500 is integrated with system manager 501 at an integrated 502. Integrator 502 can contain several components such as communicator 505 that allows interchange of data between human management 500 and system manager 501. The integrator 502 allows the human management 500 to send to the system manager 501 a set of constraints 506 and a set of expectations 507. The integrator can contain a labeling device 509 that can label data with users, such as function. The integrator can contain system 503 that studies user satisfaction, study how the system works, and learn to perform in the way that the user has maximum satisfaction. The integrator can have a connection to Internet 504 so that information can be shared over the Internet and, can be applied to the same user in the same category on different user categories. U.S. Pat. No. 6,505,208, which is hereby incorporated by reference in its entirety, describes learning over a network for educational monitoring and improving interactive skills based on participants on the network. This could be adapted for the present invention.

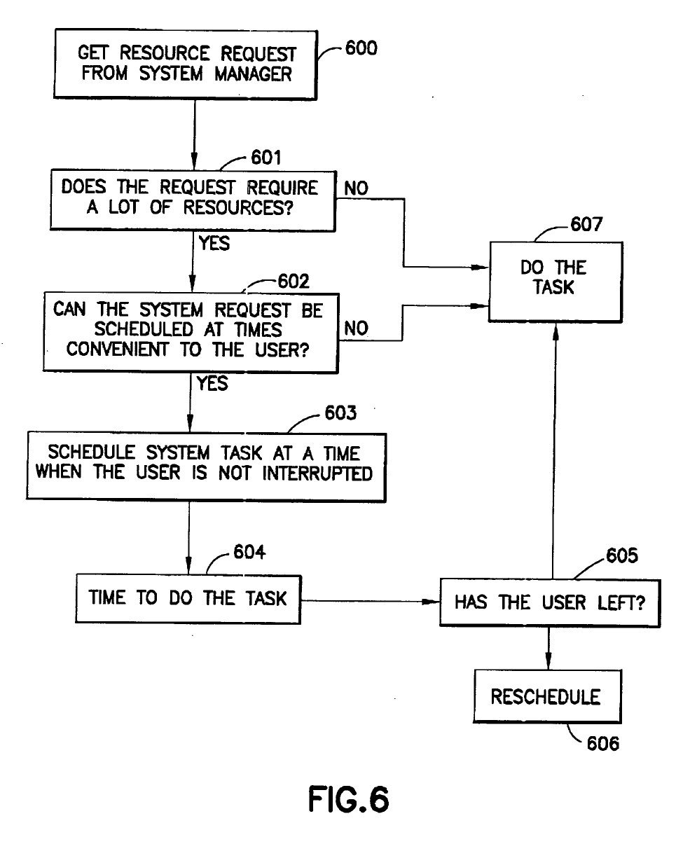

Referring also to FIG. 6 an example of one method of the invention will be described. A reference request from the system manager occurs as indicated by block 600. A determination is made at block 601 of whether or not the request require a lot of resources. This is a system check. If yes, then as shown in block 602 a determination is made as to whether this request can be scheduled at times convenient for user. If yes, as indicated by block 603 the system schedules the task at a time when user is not interrupted. As indicated by block 604 a check of time to do task is made. As indicated by block 605, if yes, a check is made to see if the user has left. If yes as indicated by block 607 the task is done. If no as indicated by block 606, then the task is reschedule. Also if it does not require a lot of resources, the task could be done without rescheduling. Or, if it cannot be scheduled at a time for user, do task by default.

The invention suggests specifying and classifying various human behavioral characteristics that can be detected via sensors and that can have effect on system management. For example, a camera could detect that a person left an office or is on the telephone. U.S. Pat. No. 6,484,130, which is hereby incorporated by reference in its entirety, describes an office accessibility information provider. This could be adapted for use with the present invention. This may imply that the user is not using a computer and, therefore, its resources could be immediately allocated to another system in the network. The system management system can also have access to a user calendar and see the user's schedules. This would allow the system to more precisely predict what resources are needed. For example if a person is on a telephone and the schedule shows that the user has a conference call, the management system can expect that the user will not use the user's computer intensively and allocate some resources to other users for the time of telephone conference call. The behavioral characteristics that can be matched to system management can be learned via observing user behavior such as using sensors and technology to classify user behavior. U.S. Pat. Nos. 6,505,208 and 6,219,639, which are hereby incorporated by reference in their entireties could be adapted for use with the present invention.

The invention relates to integrated system management with human behavior management. The system management is adapted to account for human behavior to satisfy users, but also increase efficiency of use of system resources. The management system can use biometrics, and/or history about user behavior, and/or learned user behavior, and/or interpret a user situation to judge how to perform management. For example, the system and method can perform an antivirus scan during the day when the scanning does not disturb a user. Situations during the day when scanning would not disturb a user could include when a user leaves the room, or when the management system knows the user has gone to a meeting or knows that user is doing something that requires little resources, or when the user actually notifies the system that it can perform the task or operation. The management system can use information about the user's behavior.

With the invention biometric sensors, such a camera or touch sensors for example, can be used. One can use speech recognition and natural language understanding history to understand what a user speaks. For example, if a user is telling someone over telephone “I'm going for lunch.” or maybe he put in an instant message to someone “I'm going away for one hour.” or maybe sent an email to someone, “I'll be back at 4:00.” or the system can even know or determine that someone went for vacation, then the management system and can do more basic services on the computer or use system resources more efficiently.

Another example how one can solve a problem is in regard to licensing. If the system sees that someone is not using his or her computer, but has a license for an application, the system can temporarily allow license of this application to someone else until the primary user returns it back to the computer. The system can inform other users that he/she can use this license temporarily, but that the license can at any moment be interrupted to switch it back to the first user. One can expect that if there are many users that use multiple licenses simultaneously, they can always temporarily switch license from some other users that are absent or do not work at this time with licensed application. Statistical modeling can be used to predict how many additional users can be using these licenses temporarily from other primary users with low risk that someone will be interrupted. Similarly one can solve email SPAM problems. The system can watch reaction of people to received email. If the system finds that many people immediately removed the email without opening it (for example, only looking on a subject line), the system can understand or learn that the email is most likely junk email and stop the email from being send to other users, or perhaps quietly remove the junk mail from other users' mail system if it already sent before they opened it.

Another thing is that the system can utilize access to a user's calendar and heed the person's schedule. Based upon the information in calendar, the system can schedule or not schedule different type of jobs and allocate resources based on the calendar information. For this kind of application one can use a system similar to that described in U.S. Pat. No. 6,820,096, which is hereby incorporated by reference in its entirety, that allows sharing of information in calendars.

Another example of system and human management integration is to run system updates and/or maintenance, not at the schedule times, but when the machine is underutilized. And, again, we can use biometrics or scheduling to find out when the machine is underutilized.

The invention demonstrates that user behavior (like whether the user in the office or not) can be represented as a special case of behavioral biometrics. U.S. Pat. No. 6,421,453 which is hereby incorporated by reference in its entirety, describes an apparatus and method for user recognition employing behavioral passwords. This can be used to provide a system management with the invention. U.S. Pat. No. 6,484,130 describes an office accessibility information provider which provides a technique for detecting user situation (in the office, sleeping, busy, on phone etc.). This can be used to provide a system management with the invention.

Another example of system and human management integration is improving SPAM detection and filtering technique. It is well known that even with best filters on servers some SPAM e-mail still reaches recipients. With the invention, one can observe what messages were deleted by readers and “how” they were deleted and use this information to characterize e-mail messages as SPAM and delete them from other users' mail systems. This method can be applicable to e-mail messages that have a confidence score to be characterized as SPAM. If the confidence scores are in grey area, then additional behavioral information from users that received these emails can be used to classify these e-mails more accurately. For example, if some users opened e-mail and left it in their mail system, then this is less likely to be a SPAM email. But if several users deleted this note without opening it (since SPAM content can be often understood via observation of subject line) then it is more likely that the note is SPAM. Also users can mark messages when they are deleting as SPAM. For example, one can add to a virtual delete button a mark, such as a red circle. If a user pressing the virtual delete button touches a red circle, this means that he characterized a message as SPAM.

This approach to SPAM filtering can also be extended to help users accessing emails by sorting messages based on their inferred importance. If several users did not delete a given message and spent a considerable amount of time reading it, this may be an indication that this message is important.

Another example of system and human management integration is to manage software licenses. The system and human management integration will allow monitoring if the user is using licensed software and dynamically release and obtain the license, thus making the larger pool of licenses available to other users.

In another aspect of this example, company A using company B's software is billed based on the average number of licenses used during the year. In this setting, company A makes use of the proposed system to minimize this average.

Another example of system and human management integration is in regard to running system updates/maintenance not at scheduled times, but when the machine is under utilized or not being used.

With the invention a system and method can be provided that specify and classify various individual human or group behavioral characteristics that can be detected via sensors and that can have effect on system management. A method can be provided for providing feedback comprising receiving data indicative of a physical characteristic of a first subject and data indicative of a physical characteristic of a second subject; determining an evaluation of the data; and providing a notification regarding the evaluation to a device. In another variant, performing some system work depending on user behavioral/biometrics information can be provided. In one option can the system can take into consideration status of the Instant Messenger software.

The method can use the physical characteristic of a first subject including, for example, at least one of the following:

the first subject's heart rate;

the first subject's blood pressure;

the first subject's blood sugar level;

the first subject's posture;

the first subject's weight;

the first subject's height;

the first subject's temperature;

the first subject's respiration rate;

a facial response of the first subject;

a galvanic skin response of the first subject;

a pheromone associated with the first subject;

a brain wave pattern of the first subject;

an odor generated by the first subject;

motion of the first subject;

a change in motion of the first subject;

a change in the first subject's heart rate;

a change in the first subject's blood pressure;

a change in the first subject's blood sugar level;

a change in the first subject's posture;

a change in the first subject's temperature;

a change in the first subject's respiration rate;

a change in a facial response of the first subject;

a change in a galvanic skin response of the first subject;

a change in a pheromone associated with the first subject;

a change in a brain wave pattern of the first subject; and

a change in an odor generated by the first subject.

The method can use receiving data indicative of a physical characteristic of a first subject including, for example, at least one of the following:
receiving data from at least one observer of the first subject regarding at least one physical characteristic of the first subject;
receiving data indicative of at least one physical characteristic from at least one sensor worn by the first subject; and
receiving data indicative of at least one physical characteristic from at least one sensor associated with the first subject.

The method can comprise receiving data indicative of one or more physical characteristics for each of a plurality of subjects, wherein the plurality of subjects includes the first subject and the second subject. The method can further comprise determining a pattern in the data indicative of one or more physical characteristics for each of a plurality of subjects. The method can further comprise providing a notification regarding the pattern to the device.

The method can comprise determining an evaluation of the data including, for example, at least one of the following:
determining an aggregation of data indicative of a physical characteristic for each of a plurality of subjects, the plurality of subjects including the first subject and the second subject and at least one other subject;
determining an averaging of data indicative of a physical characteristic for each of a plurality of subjects, the plurality of subjects including the first subject and the second subject and at least one other subject;
computing a result based on a function of the data;
comparing the physical characteristic of the first subject with a stored record of behavior;
comparing the physical characteristic of the second subject with a stored record of behavior;
determining a prediction regarding-at least one action that might be taken by at least one of the first subject and the second subject;
determining a risk of violence associated with at least one of the first subject and the second subject;
determining a trading propensity associated with at least one of the first subject and the second subject;
determining an action that may be taken by at least one of the first subject and the second subject;
determining an action that is desired to be taken by at least one of the first subject and the second subject;
determining a course of entertainment to provide to at least one of the first subject and the second subject;
determining probability associated with an action that might be taken by the first subject;
determining at least one response to provide at least one of the first subject and the second subject;
determining at least one option to offer at least one of the first subject and the second subject;
selecting entertainment to provide at least one of the first subject and the second subject;
selecting information to provide at least one of the first subject and the second subject;
selecting at least one environmental condition for at least one of the first subject and the second subject; and
altering at least one environmental condition for at least one of the first subject and the second subject.

The method can comprise determining which of a plurality of devices to provide the notification, and identifying the plurality of devices. The device can include, as examples, at least one of the following:

ear phones;

a speaker;

a software program;

a visual display device;

an electronic storage device;

a server; and

a user device.

The notification can include, as examples, at least one of the following:

an evaluation of the data;

an email message;

a visual display;

an electronic signal;

an audible sound; and

a voice message.

The evaluation can include, as examples, at least one of the following:
an aggregation of data indicative of a physical characteristic for each of a plurality of subjects;
an averaging of data indicative of a physical characteristic for each of a plurality of subjects;
a selection of a behavior associated with the physical characteristic of the first subject;
a selection of a behavior associated with the physical characteristic of the second subject;
a comparison of the physical characteristic of the first subject with a stored record of behavior;
a prediction regarding at least one action that might be taken by at least one of the first subject and the second subject;
a determination of a risk of violence associated with at least one of the first subject and the second subject;
a determination of a trading propensity associated with at least one of the first subject and the second subject;
a determination of a course of action;
a determination of a course of entertainment;
a determination of a probability associated with a course of action that might be taken by at least one of the first subject and the second subject;
a determination of at least one response to provide at least one of the first subject and the second subject;
a determination of a least one response to subject the first subject to;
a determination of a least one response to subject the first subject to;
a determination of at least one option to offer at least one of the first subject and the second subject;
a selection of entertainment;
a selection of information; and
a selection of at least one environmental condition.

The method can further comprise one or more of receiving a notification regarding a plurality of options, selecting one of the plurality of options based, at least in part, on the evaluation, selecting the device based, at least in part, on the selecting one of the plurality of options, determining a course of action based on the data, providing a notification based on the course of action, determining a course of action based on the evaluation, providing a notification based on the course of action. The device can be associated with at least one of the plurality of options. Determining an evaluation of the data can include comparing the physical characteristic of the first subject to at least one record of behavior associated with the physical characteristic of the first subject. The determining an evaluation can include determining a course of action based on the record of behavior. The method can also comprise determining a desired course of action and wherein the determining an evaluation of the data includes determining an action based, at least in part, on the data and the desired course of action.

The physical characteristic of the first subject can be the same as the physical characteristic of the second subject. The physical characteristic of the first subject can be different from the physical characteristic of the second subject.

A method for providing feedback can be provided comprising receiving data indicative of a physical characteristic of each of a plurality of subjects; determining a course of action based, at least in part, on the data; and providing a notification based, at least in part, on the course of action. The determining a course of action based on the data can include at least one of the following:
determining a course of action based, at least in part, on the data and a desired action that can be taken by at least one of the plurality of subjects;
determining a course of action based, at least in part, on the data and a desired action that can be taken by the plurality of subjects; and
determining at least one behavior associated with the physical characteristic.

The method can further comprise determining a desired action to be taken by the plurality of subjects. The plurality of subjects can include a first subject and a second subject, wherein the data includes data indicative of a characteristic of the first subject and data indicative of a characteristic of the second subject. The characteristic of the first subject can be different from the characteristic of the second subject.

A method for providing feedback can be provided comprising determining a desired action associated with a group of subjects; receiving data indicative of a physical characteristic of at least one of the group of subjects; determining a course of action based, at least in part, on the physical characteristic and the desired action; and providing a notification based on the course of action.

A system for facilitating feedback can be provided comprising a memory; a communication port; and a processor connected to the memory and the communication port. The processor can be adapted to receive data indicative of a physical characteristic of a first subject and a physical characteristic of a second subject; determine an evaluation of the data; and provide a notification regarding the evaluation to device.

A computer program product in a computer readable medium for using feedback can be provided comprising first instructions for obtaining receiving data representative of a physical characteristic of a first subject and a physical characteristic of a second subject; second instructions for preparing an evaluation of the data; and third instructions for sending data indicative of the evaluation of the data to a device.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A computer management system comprising:
a system manager coupled to a plurality of clients;
a user behavior system adapted to receive an individual user activity information regarding physical behavior of at least one user of at least one of the clients; and
an integrator system adapted to modify at least one operation of the system manager based upon the individual user activity information received by the user behavior system.

2. A computer management system as in claim 1 wherein the system manager comprises a server adapted to allocate system resources with the clients.

3. A computer management system as in claim 2 wherein the system manager is adapted to at least partially predict system resources needed by the clients.

4. A computer management system as in claim 2 wherein the system manager is adapted to re-allocate system resources based at least partially on the integrator system.

5. A computer management system as in claim 1 wherein the user behavior system is adapted to receive biometric information from at least one sensor.

6. A computer management system as in claim 1 wherein the user behavior system is adapted to predict the behavior of the user based upon a history of behavior of the user.

7. A computer management system as in claim 1 wherein the user behavior system is adapted to interpret a situation of a user based upon a least one input to the user behavior system

8. A computer management system as in claim 1 wherein the individual user activity information comprises an action taken regarding an email acted upon by the user.

9. A computer management system as in claim 1 wherein the individual user activity information comprises use of a software license by the user.

10. A computer management system as in claim 1 wherein the individual user activity information comprises calendar information in a user's electronic calendar on the user's client.

11. A computer management system as in claim 1 wherein the integrator system is adapted to modify an update or maintenance schedule of the client based upon the individual user activity information received by the user behavior system.

12. A computer management system as in claim 1 wherein the system manager comprises an interruption manager coupled to the user behavior system.

13. A method for operating a computer system manager comprising:
providing a user behavior system adapted to receive an individual user activity information regarding physical behavior of a user at a client coupled to the system manager; and
modifying at least one operation of the system manager based upon the individual user activity information received by the user behavior system.

14. A method as in claim 13 wherein the user behavior system comprises a sensor, and wherein the sensor senses a physical parameter regarding the user at the client.

15. A method as in claim 13 wherein the individual user activity information comprises information regarding an action by the user on an email to the user.

16. A method as in claim 13 wherein the individual user activity information comprises information regarding use of a software license by the user at the client.

17. A method as in claim 13 wherein the individual user activity information comprises information regarding a calendar appointment in a calendar of the user on the client.

18. A method as in claim 13 wherein the individual user activity information comprises information regarding telephone activity by the user.

19. A method as in claim 13 wherein modifying the at least one operation comprises re-allocating system resources by the system manager.

20. A method as in claim 13 wherein modifying the at least one operation comprises performing an electronic update or maintenance on by client.

21. A method as in claim 13 further comprising predicting system resources needed by the client based upon modifying the at least one operation of the system manager.

22. A method as in claim 13 wherein the user behavior system is adapted to interpret a situation of the user, based upon the individual use activity information, and classify the situation into at least one of a plurality of classifications for modifying the at least one operation.

23. A method for providing feedback comprising:
determining a desired action associated with a group of subjects;
receiving data indicative of a physical characteristic of at least one member of the group of subjects;
determining a course of action based, at least in part, on the physical characteristic and the desired action; and
providing a notification based on the course of action.

24. A method as in claim 23 wherein receiving data indicative of a physical characteristic of at least one member of the group of subjects comprises action by the member regarding an email.

25. A method as in claim 22 wherein receiving data indicative of a physical characteristic of at least one member of the group of subjects comprises use of a software program by the member.

26. A method as in claim 22 wherein receiving data indicative of a physical characteristic of at least one member of the group of subjects comprises a calendar appointment of the member in an electronic calendar of the member.

27. A method as in claim 22 wherein receiving data indicative of a physical characteristic of at least one member of the group of subjects comprises a biometrics sensor sending information to a system manager regarding a physical parameter of the member.

28. A method as in claim 22 further comprising predicting system resource requirements of the group of subjects on a computer system, and wherein determining a course of action comprises modifying system resources.

29. A system for facilitating feedback comprising:
a memory;
a communication port; and
a processor connected to the memory and the communication port, the processor being operative to:
receive data indicative of a physical characteristic of a first subject and a physical characteristic of a second subject;
determine an evaluation of the data; and
provide a notification regarding the evaluation to device.

30. A computer program product in a computer readable medium for using feedback, comprising:
first instructions for obtaining receiving data representative of a physical characteristic of a first subject and a physical characteristic of a second subject;
second instructions for preparing an evaluation of the data; and
third instructions for sending data indicative of the evaluation of the data to a device.
